(19) United States
(12) Patent Application Publication
(10) Pub. No.: US 2016/0206153 A1
(43) Pub. Date: Jul. 21, 2016

(54) UTENSIL WITH CONFIGURABLE HANDLE

(71) Applicant: John C. Yount, Pollock Pines, CA (US)

(72) Inventor: John C. Yount, Pollock Pines, CA (US)

(21) Appl. No.: 14/849,265

(22) Filed: Sep. 9, 2015

Related U.S. Application Data
(60) Provisional application No. 62/105,425, filed on Jan. 20, 2015.

(51) Int. Cl. A47J 43/18

(52) U.S. Cl. CPC A47J 43/18; A23L 1/0128; A23V 2002/00

(57) ABSTRACT

A utensil such as a skewer includes a two-piece handle on which one or more tine may be rotatably mounted. The pieces of the handle may be wood and are movable relative to each other to switch the handle between a compact configuration, e.g., for storage or transport, and an extended configuration for use. The mounting of each tine permits rotation of the tine between an orientation in which the tine extends away from the handle, e.g., for cooking, and an orientation in which the tine extends along a length of the handle, e.g., for storage or transport.

### CROSS-REFERENCE TO RELATED APPLICATIONS

This patent document claims benefit of the earlier filing date of U.S. provisional Pat. App. No. 62/105,425, filed Jan. 20, 2015, which is hereby incorporated by reference in its entirety.

### BACKGROUND

Outdoor cooking over an open fire dates from prehistoric times but is still popular today. Many people particularly enjoy camping, backpacking, or simply sitting around a campfire while toasting marshmallows or grilling meat, fish, or vegetables. The experience may be more enjoyable and may produce better results with modern utensils. However, many cooking utensils that are staples in kitchens are inconvenient or risky for use in an outdoor environment or are inconvenient to transport to an outdoor environment. For example, some cooking skewers are simply a metal shaft that may be stuck through food for cooking. The metal shaft conducts heat and may remain hot for several minutes after being removed from cooking heat. A user may thus need a hot pad or oven mitt when holding or handling a conventional skewer. An outdoor user often doesn't have a hot pad or an oven mitt and risks being burned when using such skewers. Additionally, conventional skewers may be cumbersome to store and transport and have a sharp end that may be exposed and may cause puncture wounds.

### SUMMARY

In accordance with an aspect of the invention, a cooking utensil has a two-piece insulating handle and a tine mount for rotatably mounting one or more tines on one piece of the handle. Each of the tines may particularly be rotated from deployed or extended configuration in which the tine extends away from the handle for use and a compact configuration in which the tine runs along the length of the handle for safety and for compact storage and easy transport. The two-piece handle allows the pieces of the handle to be moved between an extended configuration in which the pieces are end to end and a compact configuration in which lengths/sides of the pieces are adjacent to each other. Similarly, the tine mount may permits each tine to be rotated between an orientation in which the tine extends from the handle and an orientation in which the tine extends along the length of a handle piece. Accordingly, the utensil including tines has a compact configuration for storage or transport and an extended configuration for use.

One specific implementation is a utensil including a handle and one or more tines. That handle includes two pieces that are movable relative to each other to switch the handle between a compact configuration and an extended configuration. Each tine may be mounted on the handle in a manner that permits rotation of the tine between a first orientation in which the tine extends away from the handle and a second orientation in which the tine extends along a length of the handle.

Another specific implementation is a utensil including a handle and a tine mount. The handle includes first and second pieces that are movable relative to each other to switch the handle between a compact configuration and an extended configuration. The tine mount is on one of the handle pieces and is operable to attach a tine to the handle in a manner that permits rotation of the tine between a first orientation in which the tine extends away from the handle and a second orientation in which the tine extends along a length of the handle.

### BRIEF DESCRIPTION OF THE DRAWINGS

FIG. 1 shows utensil in accordance with an embodiment of the invention when assembled and configured for use.

FIG. 2 shows the utensil of FIG. 1 with a two-piece handle disassembled.

FIG. 3A shows the utensil of FIG. 1 when configured for transport or storage with tines attached.

FIG. 3B shows the utensil of FIG. 1 when configured for transport or storage with tines removed.

The drawings illustrate examples for the purpose of explanation and are not of the invention itself. Use of the same reference symbols in different figures indicates similar or identical items.

### DETAILED DESCRIPTION

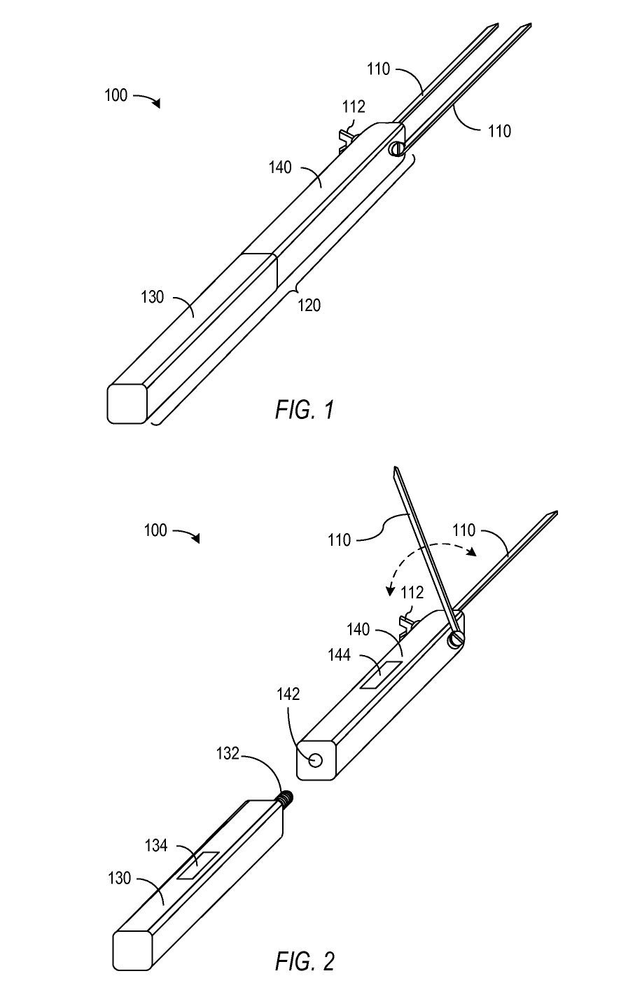

A utensil as disclosed herein may be configured for use or for compact storage or transport. FIG. 1 shows a utensil 100 in accordance with an exemplary embodiment of the invention when utensil 100 is in an extended configuration for use. Utensil 100 may primarily be a cooking tool and might also be referred to as skewer, a toasting stick, or a roasting stick to name just a few common utensil names currently in use. Utensil 100 includes one or more tines 110 attached to a two-piece handle 120. For cooking over an open fire, coals, or other heat source, tines 110 may be inserted through food to be heated or cooked and then placed at least partially into or over the heat source, e.g., into or over the flames of a camp fire, and a user may hold utensil 100 by handle 120 while tines 110 are in or over the heat source or fire.

FIG. 1 shows an example in which utensil 100 has two tines 110, but alternatively a utensil might have any number of tines, e.g., just one tine 110 or multiple tines 110. Each tine 110 may be made of a metal or other fire resistant material and has a free end and an attached end. The free end may be pointed for skewering food, and the attached end may be shaped for mounting on handle 120. For example, each tine 110 may have an “eye” on the end attached to handle 120 and have a diagonally cut or sharpened free end. In one specific implementation, each tine 110 may be made of food grade stainless steel or chrome plated steel. The length of each tine 110 may be chosen according to the intended use of utensil 100 and for use in a campfire may be about six inches to twelve inches in length. The structure of each tine 110 may also be chosen for the intended use of utensil 100. For example, tines 110 may have a cross-section that is round, square, rectangular, or flat. The gage or thickness of tines 110 may chosen for different uses but may commonly be less than one-quarter inch.

Handle 120 has a multi-piece construction and in the illustrated embodiment includes an end piece 130 and a tined piece 140. Each handle piece 130 or 140 may be made of a poor thermal conductor or a thermal insulator to allow safe handling of handle 120 while all or portions of tines 110 may be hot or in or near a heat source. The material of pieces 130 and 140 may further be selected to be light weight so that utensil 100 floats if dropped into water, which may be particularly important if utensil 100 is carried during hiking, backpacking, boating, or many other outdoor pursuits. In one specific embodiment, handle pieces 130 and 140 are primarily made of wood, which floats and is a poor thermal conductor. The wood may be natural and untreated, e.g., not painted or varnished, to avoid problems that might arise when coatings or treatments are exposed to heat or flame.

In the exemplary embodiment, handle pieces 130 and 140 have a substantially rectangular, square, or squared-off cross-section, which provides flat surfaces on which tines 110 may be mounted and flat surfaces for arranging handle pieces in a compact configuration as describe further below. For example, handles pieces 130 and 140 may be made of ¾ inch by ¾ inch pine or oak, which provides a convenient size for gripping and provides suitable separation between tines 110 when tines 110 are mounted on opposite surfaces of handle 120. However, handle piece 130 and 140 could have any cross-sectional shape, e.g., rectangular, square, round, or oval, or may have a variable cross-section, e.g., an end knob or a contoured grip. In another example implementation, handle pieces 130 and 140 may be bamboo and may have an irregular cross-section.

Handle pieces 130 and 140 may have any desired length and particularly may have lengths chosen according to the intended use of utensil 100. However, a typical length for each handle piece 130 and 140 may be about twelve inches, so that handle 120 has an overall length of about two feet in the extended configuration. In one specific implementation, handle piece 140, on which tines 110 are mounted, is about 13.5 inches in length, and handle piece 130 about 12 inches in length, including a steel bolt which may extend beyond the wood portion for insertion into an insert nut in the other handle piece 140. In this specific implementations, depending on length of tines 110, utensil 100 may have an overall length of about 32 to 34.5 inches with tines 110 extended for cooking as shown in FIG. 1.

FIG. 1 shows tines 110 as extending parallel to the lengths of handle 120, which may good arrangement for use of utensil 100, e.g., when tines 110 hold food in a fire. Other arrangements of tines 110, e.g., at a non-zero angle to the length of handle 120, could also be advantageous for some uses of utensil 100. Tines 110 are rotatably mounted on tined handle piece 140 to allow a user to control the angle between tines 110 and handle 120. Many types of rotatable mountings could be used for tines 110. In the embodiment of FIG. 1, the rotatable mounting of tines 110 to handle piece 140 includes a tine mount 112 including a bolt and a wing nut that a user without tools can easily loosen for rotation of tines 110 or tighten to resist movement of tines 110 while tines 110 are in desired positions. Tine mount 112 also permits removal of tines 110 from handle 120, for example, for sanitation, e.g., for washing of tines 110 or removal of food from tines 110, or for storage of utensil 100. Tine mount 112 also allows tines 110 to be replaced or swapped. In particular, a user may replace or swap tines 110 to prepare utensil 100 for cooking different foods, e.g., tines 110 for cooking chicken may be removed and replaced with tines 110 for toasting marshmallows. Any tine or skewer that may be commercially available, for example, at stores that sell cooking and outdoor supplies, may be installed on handle 120 as tines 110 provided that the tine or skewer has a suitable eye for mounting with bolt mounting system 112, allowing a user to easily use a wide variety of tine types on handle 120. A user may also change the number of tines 110 installed on utensil 100. Two tines 110 may be a particularly “common” and useful configuration, but one tine might be used to accommodate a user with limited grip strength or holding ability. For all such alterations, the removal and/or reinstallation tines 110 using bolt and wing nut mounting system 112 may be easily and quickly completed without tools.

FIG. 2 shows utensil 100 in configuration in which one of tines 110 has be rotated away from parallel to handle piece 140. FIG. 2 also illustrates how handle pieces 130 and 140 may be dethatched from and moved relative to each other. In the embodiment illustrated in FIG. 2, handle pieces 130 and 140 have respective threaded structures 132 and 142. For example, either handle piece 130 or 140 may have a metal threaded projection that matches a metal threaded insert in the other handle piece 140 or 130, so that handle pieces 130 and 140 may be attached together end-to-end or detached without tools simply by hand tightening or loosening threaded structures 132 and 142. Other attachment structures could alternatively be employed to attach pieces 130 and 140 end-to-end for the extended configuration. For example, handle pieces 130 and 140 could be connected using a hinge and latch system (not shown) that permits movement or rotation of pieces 130 and 140 between extended and compact configurations.

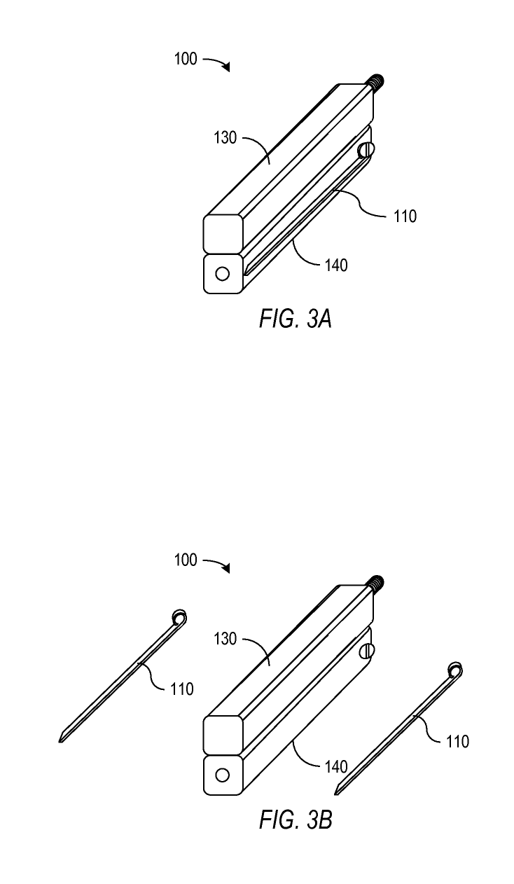

Handle pieces 130 and 140 may also include attachment structures 134 and 144 for attaching handle pieces 130 and 140 together in a compact configuration. For example, attachment structures 134 and 144 may be mating pads of a hook and loop fastener, e.g., Velcro. FIGS. 3A and 3B show utensil 100 in compact configurations in which attachment structures 134 and 144, which are not visible in FIG. 3A or 3B, are in contact and hold lengths of handle pieces 130 and 140 together side-by-side, rather than end-to-end as shown in the extended configuration of FIG. 1. Alternatively, a closable or elastic loop (not shown) may fit around handle pieces 130 and 140 and hold handle pieces 130 and 140 in a compact configuration. An advantage of the illustrated implementation of utensil 100 in which handle pieces 130 and 140 have square or rectangular cross-sections is that flat surfaces of handle pieces 130 and 140 abut each other in the compact configurations of FIG. 3A or 3B.

Tines 110 in the compact configuration of FIG. 3A are rotated to run along the length of handle piece 140. Tines 110 may be about the same length or shorter than handle piece 140, so that sharp ends of tines 110 do not extend beyond the end of handle 140 in the compact configuration of FIG. 3A. Accordingly, sharp ends of tines 110 may be less exposed, which may decrease the risk of injury or property damage while utensil 100 is not in use.

The compact configuration of FIG. 3A also illustrates advantages of specific proportions of the exemplary embodiment. In particular, tines 110 and each handle piece 130 and 140 and tines 110 may have similar lengths, e.g., about one third of the fully extended configuration of utensil 100 shown in FIG. 1. In particular, a full length of about three feet may provide a comfortable distance between a fire and a user hold handle 120, and each of parts 110, 130, and 140 may be about a foot long. A length of six inches or more for tines 110 may also keep handle piece 140 (and handle piece 130) far enough away from a fire to avoid direct scorching and avoid scorching from heat conduction along tines 110 even when handle piece 140 is made of a flammable material such as wood or plastic.

Tines 110 in the compact configuration of FIG. 3B are removed and may be stored or transported separately from handle pieces 130 and 140. In particular, tines 110 shown in FIG. 3B may be stored with a collection of interchangeable tines (not shown) of different types, e.g., for cooking different types of food.

Utensil 100 may be employed for cooking as disclosed herein but may also be used for other purposes. Embodiments of a utensil such as disclosed herein may be suitable for any applications where a pointed instrument is desired. For example, an embodiment of a pointed utensil might also be used as a spear or a gig.

Although particular implementations have been disclosed, these implementations are only examples and should not be taken as limitations. Various adaptations and combinations of features of the implementations disclosed are within the scope of the following claims.

What is claimed is:

1. A utensil comprising:
a handle including a first piece and a second piece, the second piece being movable relative to the first piece to switch the handle between a compact configuration and an extended configuration; and
a tine mount on the first piece, wherein the tine mount is operable to attach a tine to the first piece and to permit rotation of an attached tine between a first orientation in which the tine extends away from the first piece and a second orientation in which the tine extends along a length of the first piece.

2. The utensil of claim 1, further comprising a first tine that the tine mount attaches to the first piece.

3. The utensil of claim 2, further comprising a second tine that the tine mount attaches to the first piece, wherein tine mount holds an end of the first tine adjacent to a first flat surface of the first piece and holds an end of the second tine adjacent to a second flat surface of the first piece.

4. The utensil of claim 3, wherein the tine mount comprises a bolt that extends through the first piece between the first and second flat surfaces and mounts the first and second tines respectively on the first and second flat surfaces.

5. The utensil of claim 3, wherein the first piece has a square cross-section having the first flat surface at one side of the square cross-section and the second flat surface at an opposite side of the square cross-section.

6. The utensil of claim 2, wherein;
the first piece comprises a first piece of wood;
the second piece comprises a second piece of wood; and
the first tine comprises metal piece having a free end extending away from the first piece and an attached end that the tine mount affixes to the first piece.

7. The utensil of claim 1, wherein:
one of the first and second pieces comprises a threaded insert; and
another of the first and second pieces comprise a threaded projection shaped to engage the threaded insert to hold the handle in the extended configuration.

8. The utensil of claim 1, further comprising:
a first attachment structure that attaches the first and second piece together in the extended configuration; and
a second attachment structure that attaches the first and second piece together in the compact configuration.

9. The utensil of claim 8, wherein the first attachment structure comprises:
a threaded insert in one of the first and second pieces; and
a threaded projection in another of the first and second pieces comprise, the threaded projection being shaped to engage the threaded insert.

10. The utensil of claim 8, wherein the second attachment structure comprises a hook and loop fastener applied to hold the first and second pieces in the compact configuration.

11. The utensil of claim 1, wherein the first piece has a length equal to a length of the second piece.

12. A utensil comprising:
a handle including a first piece and a second piece, the second piece being movable relative to the first piece to switch the handle between a compact configuration and an extended configuration; and
a first tine mounted on the first piece in a manner that permits rotation of the tine between a first orientation in which the tine extends away from the first piece and a second orientation in which the tine extends along a length of the first piece.

13. The utensil of claim 1, further comprising a second tine mounted on the first piece, wherein the first tine is mounted on a first flat surface of the first piece, and the second tine is mounted on a second flat surface of the first piece.

14. A method comprising:
connecting a first piece and a second piece end-to-end to form a handle;
rotating a first tine that is mounted on the first piece from a first orientation in which the first tine extends along a length of the first piece to a second orientation in which the first tine extends away from the first piece;
skewering a food item with the first tine; and
holding the handle while the food item skewered on the first tine heats over a fire.

15. The method of claim 14, wherein connecting the first piece and the second piece comprises
inserting a threaded projection extending from one of the first and second pieces into a threaded insert in the other of the first and second pieces; and
rotating the first and second pieces relative to each other to tighten the threaded projection in the threaded insert.

16. The method of claim 14, further comprising rotating a second tine that is mounted on the first piece between an orientation in which the second tine extends along the length of the first piece and an orientation in which the second tine extends away from the first piece.

17. The method of claim 14, further comprising:
removing the food item from the first tine;
rotating the first tine from the second orientation back to the first orientation;
disconnecting the first and second pieces; and
storing the first and second pieces with a side of the first piece adjacent to a side of the second piece.
